(19) United States
(12) Patent Application Publication
(10) Pub. No.: US 2024/0422073 A1
(43) Pub. Date: Dec. 19, 2024

(54) METHODS AND APPARATUS FOR ADAPTIVE EXCHANGE OF ARTIFICIAL INTELLIGENCE/MACHINE LEARNING (AI/ML) PARAMETERS

(71) Applicant: Huawei Technologies Co., Ltd., Shenzhen (CN)

(72) Inventors: Hao Tang, Ottawa (CA); Jianglei Ma, Ottawa (CA)

(21) Appl. No.: 18/813,506

(22) Filed: Aug. 23, 2024

Related U.S. Application Data
(63) Continuation of application No. PCT/CN2022/077691, filed on Feb. 24, 2022.

(51) Int. Cl. H04L 41/16; H04W 24/02

(52) U.S. Cl. CPC H04L 41/16; H04W 24/02

(57) ABSTRACT

Methods and apparatus for adaptive exchange of artificial intelligence/machine learning (AI/ML) parameters are disclosed. Within a radio access network (RAN) of a wireless communication network and between a user equipment (UE) and a network device, one or more of a plurality of subsets of AI/ML parameters are communicated. A subset of the plurality of subsets of the AI/ML parameters is communicated according to a transmission configuration, by the network device, for the subset.

### CROSS-REFERENCE TO RELATED APPLICATION

The present application claims priority from PCT Application No. PCT/CN2022/077691, filed on Feb. 24, 2022. The contents of this priority application are incorporated herein by reference.

### TECHNICAL FIELD

The present disclosure relates generally to wireless communications and, in particular embodiments, to adaptive techniques for exchanging artificial intelligence/machine learning (AI/ML) parameters between a user equipment (UE) and a network device in a wireless communication network.

### BACKGROUND

In wireless federated learning (FL), a base station (BS) initializes a global model, samples a group of UEs, and broadcasts the global model parameters to the UEs. Each UE initializes its own local model using the global model parameters, and updates (trains) its local model using its own data. Then each UE reports the parameters of its updated local model to the BS. The BS aggregates the parameters reported from the UEs and updates the global model. The aforementioned procedure is one iteration of AI training procedure. The BS and UEs perform multiple iterations until the AI model is finalized.

For other AI/ML training procedures, such as distributed learning, centralized learning, and learning between one BS and one UE, high communication overhead during training can also be a concern.

### SUMMARY

The present disclosure encompasses embodiments that may help reduce communication overhead involved in AI/ML training procedures.

According to an aspect of the present disclosure, a method involves communicating, within a radio access network (RAN) of a wireless communication network and between a UE and a network device, one or more of a plurality of subsets of AI/ML parameters. The communicating involves communicating a subset of the plurality of subsets of the AI/ML parameters according to a transmission configuration, by the network device, for the subset.

An apparatus according to another aspect of the present disclosure includes a processor and a non-transitory computer readable storage medium that is coupled to the processor. The non-transitory computer readable storage medium stores programming for execution by the processor. The programming includes instructions to, or to cause the processor to, communicate, within a RAN of a wireless communication network and between a UE and a network device, one or more of a plurality of subsets of AI/ML parameters. A subset of the plurality of subsets of the AI/ML parameters is communicated according to a transmission configuration, by the network device, for the subset.

A computer program product includes a non-transitory computer readable medium storing programming, and the programming includes instructions to, or to cause a processor to, communicate, within a RAN of a wireless communication network and between a UE and a network device, one or more of a plurality of subsets of AI/ML parameters. As in other embodiments, a subset of the plurality of subsets of the AI/ML parameters is communicated according to a transmission configuration, by the network device, for the subset.

These and other aspects or embodiments are disclosed herein.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating an example of an AI/ML model.

FIG. 6 is a block diagram illustrating selective transmission of model parameters for the example an AI/ML model of FIG. 5 according to an embodiment.

FIG. 7 is a block diagram illustrating adaptive quality of service (QOS) handling of model parameters for the example an AI/ML model of FIG. 5 according to an embodiment.

FIG. 8 is a signal flow diagram illustrating interactions between a UE and a network device in some embodiments.

### DETAILED DESCRIPTION OF THE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

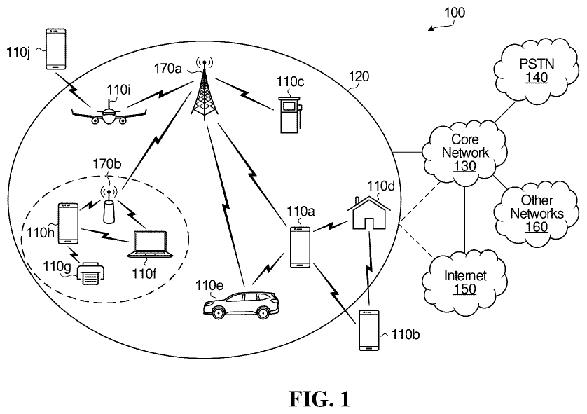

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

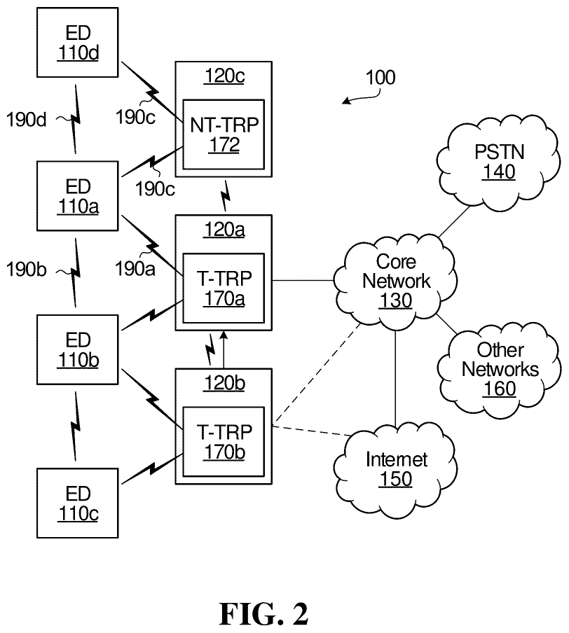

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

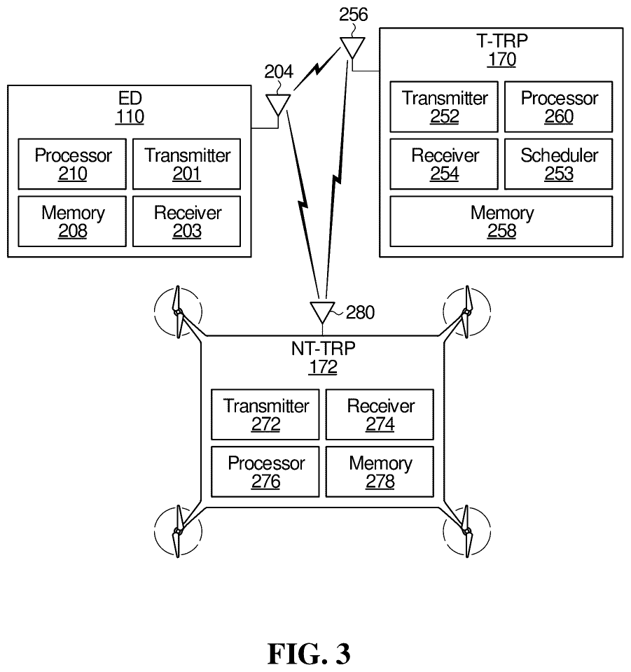

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

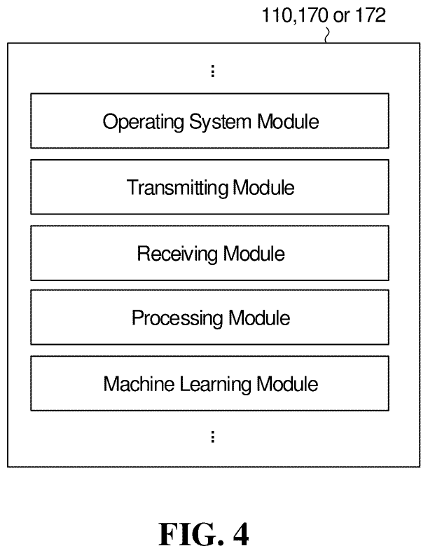

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Embodiments disclosed herein relate primarily to exchanging AI/ML parameters in a wireless communication network, and may help reduce communication overhead associated with such parameter exchange.

AI/ML parameters, such as weights of connections, of certain layers in an AI/ML model may converge at different rates. For example, the first layers tend to converge faster than the last layers of a model. Therefore, for an iteration of DL transmission of updated parameters for example, a network device such as a BS could perform high priority transmission of parameters for near-converged layers, and low priority transmission for other layers, so as to reduce communication overhead in each iteration.

In some embodiments, for an iteration, parameters of only some layers are transmitted, and previous values of other parameters remain unchanged in a model. For DL transmission for example, a network device may transmit updated values of parameters for certain layers and not other layers, and for parameters of those other layers, UEs use values in a previous update.

According to other embodiments disclosed herein, for an iteration, QoS handling is separately configured for respective subsets of parameters. For example, a network device may transmit multiple subsets of parameters with different QoS handling.

Although federated learning and distributed learning are referenced herein, it should be noted that embodiments are not limited to AI/ML training in federated learning or distributed learning. Features disclosed herein may also or instead be applied to AI/ML training in other learning methods or scenarios, including centralized learning, auto-encoder, deep neural network (DNN), convolutional neural network (CNN), etc.

Different subsets of parameters may be transmitted at different times, for different iterations for example. This may be referred to as selective transmission during training or during an AI/ML training procedure.

For example, during an AI/ML training procedure, in a DL iteration, a network device may indicate which parameters are updated, and the updated values of those parameters, to a UE. Based on feedback received from one or more UEs, for example, a network device may know or determine which layers of a model are near-converged, or closer to convergence than other layers, and the network device may transmit only the weights between those layers in order to reduce overhead relative to a full parameter update of all parameters in a model.

FIG. 5 is a block diagram illustrating an example of an AI/ML model. The example model 500 includes inputs 510, outputs 550, and N layers, three of which are labeled at 520, 530, 540. Each layer includes one or more neuron nodes 522, 532, 542, and layers may include different numbers of nodes, as shown by way of example in layer 1 with m nodes and layer 2 with k nodes. More generally, a layer may include one or more nodes, and the number of nodes in any layer may be the same as or different from the number of nodes in another layer. Connections between nodes of different layers are also shown in FIG. 5, and the wij parameters represent weights between the ith node of one layer and the jth node of the next layer in the model.

The model shown in FIG. 5 is one simple example of an AI/ML model. The features disclosed herein are not limited to this or any other particular model.

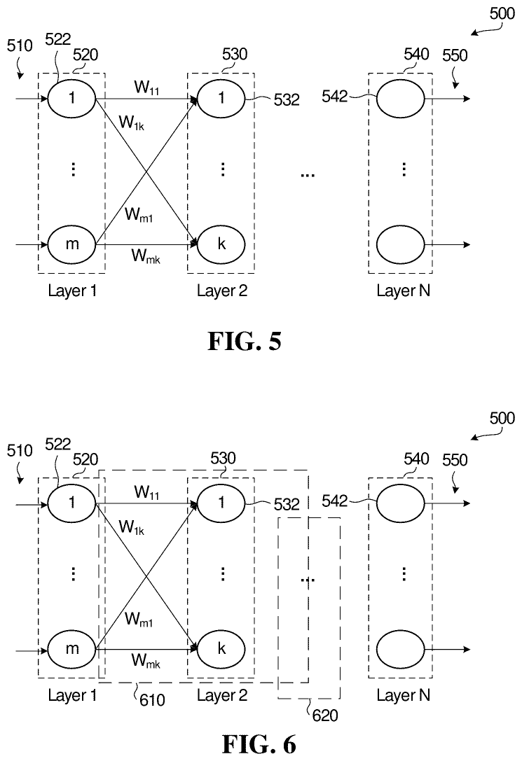

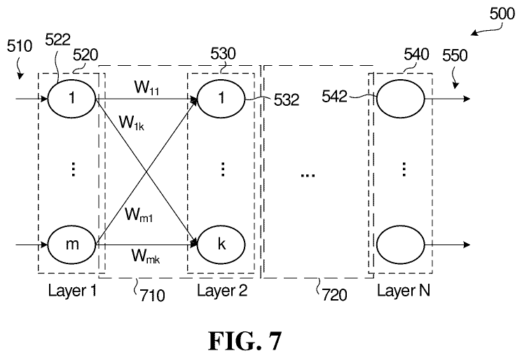

FIG. 6 is a block diagram illustrating selective transmission of model parameters for the example an AI/ML model of FIG. 5 according to an embodiment. The model 500 in FIG. 5 is reproduced in FIG. 6, with additional dashed-line boxes 610, 620 representing layers for which parameters are selectively transmitted. Solely for the purpose of illustration, suppose that there are multiple DL iterations during training of the model 500, and that N is 8 or greater. At an iteration M, a network device may indicate to one or more UEs that model parameters (weights, for example) between layer 1 at 520 and layer 4 (not shown) are transmitted, and also indicate the values of the indicated parameters. The box 610 in FIG. 6 is intended to designate these model parameters for iteration M. At another iteration M+K, the network device may indicate to the UE(s) that model parameters (weights, for example) between layer 3 and layer 7 (not shown) are transmitted, and indicate the value of the indicated parameters. The box 620 in FIG. 6 is intended to designate these model parameters for iteration M+K. By such selective transmission, communication overhead can be reduced significantly relative to full model parameter updates at every iteration.

In the example described above with reference to FIG. 6, communicating AI/ML parameters between a UE and a network device involves a network device transmitting the parameters to a UE, but from a UE perspective communicating parameters involves the UE receiving the parameters from the network device. UL iterations or training are also possible, in which case communicating parameters involves, from a UE perspective, the UE transmitting the parameters to the network device, and from a network device perspective, the network device receiving the parameters from the UE.

According to embodiments disclosed herein, communicating AI/ML parameters involves communicating one or more subsets of the AI/ML parameters, within a RAN of a wireless communication network. In next generations of wireless communication networks, including for example the sixth generation (6G), it is contemplated to provide for communications of messages within one or more RANs. These messages, which may comprise local traffic signaling or data and are referred to as first messages, are associated with a new message type, referred to as a first message type. In possible implementations, messages of the first message type may comprise different data such as sensing data (environment data collection), virtual and augmented reality data (VR/AR), ubiquitous or pervasive instant communication data, AI training data, AI intermediate training results data, and the like. Alternatively, messages of the first message type may comprise traffic signaling. The first messages may comprise control signaling or data in physical layer or high layer, and consequently can be communicated on the control plane (CP) or on the user plane (UP), for downlink, uplink, and sidelink communications. This is in contrast with techniques that involve communicating AI/ML parameters via a core network (CN) of the wireless communication network. As referenced herein, communicating within a RAN is intended to mean not communicating through a CN.

Each subset AI/ML parameters includes fewer than all of the AI/ML parameters for an AI/ML model. In communicating AI/ML parameters as disclosed herein, a subset of AI/ML parameters is communicated according to a transmission configuration, by the network device or possibly by the UE, for the subset. One subset may be communicated at a time, in embodiments that are referred to herein as involving selective transmission, or multiple subsets may be communicated according to respective transmission configurations for the multiple subsets. Whether one subset or multiple subsets are communicated at a time, the communicating involves communicating a subset according to a transmission configuration for that subset.

In the case of the network device determining the transmission configuration(s) for the parameter subset(s), a method may involve communicating the transmission configuration(s) from the network device to one or more UEs via radio resource control (RRC) signaling, medium access control (MAC) control element (MAC-CE) signaling, or downlink control information (DCI) signaling, for example. The UE(s) then apply the transmission configuration(s), at least for UL iterations for example. One or more transmission configurations may also or instead be communicated from a network device to a UE for use by the UE in DL training, to determine how parameters are to be transmitted to the UE by the network device for example. For DL training, the transmission configuration(s) need not be separately communicated to a UE, and a network device may instead indicate to the UE the parameters that are being transmitted and the values of those parameters, as described at least above with reference to FIG. 6.

In some embodiments, a UE may determine the transmission configuration(s) for one or more parameter subsets, in which case a method may involve communicating the transmission configuration(s) from the UE to the network device. The network device then applies the transmission configuration(s), for UL training to determine how parameters are transmitted to the network device by the UE and/or for DL training to determine how parameters are to be transmitted by the network device to the UE. A transmission configuration that is determined by a UE need not be separately communicated to a network device, and a UE may instead indicate to the network device the parameters that are being transmitted and the values of those parameters, similar to the approach described at least above with reference to FIG. 6 for a network device transmitting parameters in DL iterations.

Selective transmission illustrates one form or type of transmission configuration for a subset of AI/ML parameters, and in particular provides an example of a transmission configuration that indicates transmission of only one subset of AI/ML parameters. This is also referred to herein as selective transmission. In the example described above with reference to FIG. 6, transmission configurations for respective subsets of parameters may include a first transmission configuration to selectively transmit only a subset of the full set of model parameters, for layers 1 to 4 (designated by 610) at iteration M, and a second transmission configuration to selectively transmit only another subset of the full set of model parameters, for layers 3 to 7 (designated by 620) at iteration M+K.

Subsets of parameters need not necessarily be entirely different. Subsets may overlap or have some parameters in common. For example, multiple subsets may include common AI/ML parameters. The partial overlap between boxes 610, 620 in FIG. 6 is intended to illustrate partial overlap between different subsets, with two subsets both including at least some common parameters.

Communicating parameters between a network device and a UE may involve communicating an indication of the AI/ML parameters that are being communicated, and values of the AI/ML parameters.

An indication of the AI/ML parameters that are being communicated may be or include, for example, an indication of one or more model layers for which associated parameters are communicated. An indication sent from a network device to a UE, or from a UE to a network device for UL training, may be or include an index list of connections between layers, indicating the connections or layers between which connection weights are being communicated, for example.

In one embodiment, an indication of AI/ML parameters that are being communicated is or includes a bitmap of connection indices, also referred to herein as a connection bitmap, that indicates whether the AI/ML parameters that are being communicated include weights for connections between respective pairs of AI/ML model layers. For N layers as illustrated in FIG. 6 for example, there are N−1 sets of connections between adjacent layers. A bitmap of length N−1 bits may be used to indicate whether the weights for each set of connections, between each pair of adjacent layers, may be communicated between a network device and a UE. In a connection bitmap, a value 1 may be used to indicate that the weights of a set of connections between layers are being communicated, and a value 0 may be used to indicate that the weights of a set of connections between layers are not being communicated. Bit designations in a connection index bitmap may be reversed in other embodiments.

A bitmap of connection index groups, also referred to herein as a connection group bitmap, is another option for an indication of AI/ML parameters that are being communicated. A size of connection group, for example a size=K, may be determined or otherwise configured by a network device, or by a UE. All connection groups may be of the same, common size, or different connection groups may have different sizes. A connection group includes consecutive connections between a series of layers in an AI/ML model. For N layers as illustrated in FIG. 6 for example, there are N−1 sets of connections between layers, and in the case of common connection group size K the number of connection groups is X=[(N−1)/K]. A bitmap of length X bits may be used to indicate, with one bitmap bit per connection group such that each group is individually addressable, whether the AI/ML parameters that are being communicated include weights for each connection group, or in other words for consecutive connections between respective series of AI/ML model layers. In such a bitmap, a value 1 (or 0) may be used to indicate that the weights for a connection group are being communicated, and a value 0 (or 1) may be used to indicate that the weights for a connection group are not being communicated.

Another form of indication of the AI/ML parameters that are being communicated is an indication of a connection start location, such as an initial model layer or starting model layer at which connections begin, and a connection length of connections for which the AI/ML parameters that are being communicated include connection weights. In such embodiments, the indication identifies a set of contiguously reported connections, and includes the start location of the connections and the number of indicated connections.

Regarding parameter values that are communicated, updated weights of indicated connections are one example. Weights may be communicated as exact or absolute values of updated weights, or as delta values relative to previous values.

Other parameters may also or instead be communicated. For example, communicating AI/ML parameters between a network device and a UE may involve communicating any one or more of the following:
gradients of the weight of indicated connections;
bias of neuron nodes in indicated connections;
a learning rate for one or more connections in an AI/ML model for which the AI/ML parameters include connection weights—this may include a single learning rate for indicated connections or a respective separate learning rate for each indicated connection;
convergence of the indicated connections, to indicate whether a connection is near converged, such as 1 bit for a connection and value 1 (or 0) indicating that a connection is near converged and value 0 (or 1) indicating that a connection is not near converged.

For DL learning or a DL iteration M, for parameters such as weights, gradient, etc. for connections that are indicated by a network device, a UE uses the parameter values communicated by the network device for local AI/ML learning. For other parameters such as weights, gradient, etc. for connections that are not indicated by the network device, the UE uses current parameter values, such as parameter values of a previous local iteration, which is iteration M−1 in this example, for local AI/ML learning.

Similarly, for UL learning, updated parameter values communicated by the UE are used by the network device, and for other parameters current values may be used by the network device.

Although transmission configurations for parameter subsets may be determined by either a network device or a UE, such transmission configurations may or may not necessarily be communicated between a network device and a UE. For example, a network device may determine transmission configurations for selective transmission of parameter subsets and indicate the included parameters and parameter values to one or more UEs in DL training, without necessarily also communicating transmission configurations to the UEs. In this example communicating the parameters by the network device is according to the transmission configurations, but the transmission configurations are not communicated.

For UL learning, however, if a network device determines the transmission configurations, and configures which parameters are to be communicated from a UE for selective transmission for example, the transmission configurations are communicated to the UE so that the UE can apply the configurations in communicating parameters to the network device. Transmission configurations for UL learning may include, for example, an index list of connection between layers, and whether a parameter type is reported. Examples of parameter type include weights, gradients, bias, learning rate, and convergence of connections. According to the transmission configurations for parameter subsets, the UE sends a UL report to inform the network device of parameter values, for a current iteration for example.

Another option for UL learning involves a UE informing a network device of the transmission configurations in UL reports for local model updates, when UL report contents are determined by the UE. For example, a UL report may include, in the first bits of the report or elsewhere, an indication of transmission configuration or format of the report, including an index list of connections between layers and whether a parameter type is reported in some embodiments. Remaining bits of a UL report include parameter values according to the configuration for a current subset of parameters that is being communicated.

By selective transmission, communication overhead can be reduced significantly, relative to reporting all parameters in every learning update or iteration.

Transmission configurations are not limited to selective transmission. Other embodiments involve adaptive quality of service (QOS) handling during training. For example, a transmission configuration may indicate QoS handling for a subset. Transmission configurations for different subsets may indicate different QoS handling, or the same QoS handling, for respective subsets of AI/ML parameters.

With adaptive QoS handling, for a DL update for example, a network device may transmit one or more subsets of parameters, for near-converged layers for example, and other subsets of parameters, for latter layers that are not as close to convergence, with different QoS. Parameters with higher importance or higher priority, which are associated with higher priority model layers based on convergence or one or more other criteria, may be transmitted using a high quantization level and hybrid automatic repeat request (HARQ) acknowledgement (HARQ-ACK) for near-converged layers for example, and other parameters may be transmitted using a low quantization level and no HARQ-ACK. Similar adaptive QoS handling may be applied to UL communication of AI/ML parameters.

Quantization level and HARQ-ACK support are examples of QoS handling features or conditions that may be specified or indicated for subsets of AI/ML parameters in adaptive QoS handling embodiments. More generally, QoS handling indicated by a transmission configuration may include any one or more of: quantization, acknowledgement/negative acknowledgement (ACK/NACK) support, and re-transmission support, any or all of which may be the same or different for different subsets of parameters.

In selective transmission, communication of AI/ML parameters is adaptive in the sense that different subsets of parameters are communicated at different times, such as in different iterations. In adaptive QoS embodiments, the same or different subsets of AI/ML parameters may be communicated, but QoS handling for any subset may change over time.

FIG. 7 is a block diagram illustrating adaptive QoS handling of model parameters for the example an AI/ML model of FIG. 5 according to an embodiment. The model 500 in FIG. 7 is the same as in FIG. 5, but with dashed boxes 710, 720 designating respective subsets of AI/ML parameters for which transmission configurations indicate QoS handling that is to be applied. For a learning iteration, for example at time slot n, the multiple subsets of parameters 710, 720 are communicated with QoS handling according to respective transmission configurations for those subsets. QoS handling may be the same or different for the different subsets, but each subset has a respective transmission configuration.

As an example, consider an embodiment in which different QoS handling is applied to subsets 710, 720. For a high priority subset, such as weights of connections which are near-converged for example, QoS handling may involve a high quantization level with N1 bits for a weight, compared to a low quantization level with N2 bits for a weight (N2<N1) for a low priority subset, such as weights of other connections. A transmission configuration for a high priority subset may also or instead specify support for ACK/NACK and/or re-transmission, compared to no ACK/NACK or re-transmission support for a low priority subset.

For ACK/NACK and re-transmission support, in some embodiments a high priority subset may be carried in one or more code block groups (CBGs), and a receiver, in particular a UE for DL learning or a network device for UL learning, applies HARQ-ACK feedback and re-transmission for the CBG(s) carrying the high priority subset. If payload size of parameter-related data to be communicated is less than the number of bits in the CBG(s), then zero bits could be appended to achieve size alignment. Optional separate modulation order and/or coding rate may be applied for the CBG(s) carrying the high priority subset. For example, a robust modulation and coding scheme (MCS) may be used for reliable transmission for CBG(s) carrying high priority subsets. Low priority subsets may be carried in one or more other CBGs, with no HARQ-ACK feedback or re-transmission.

More generally, QoS handling as indicated by a transmission configuration may involve assigning a subset of AI/ML parameters to one or more CBGs. Communicating parameters may involve communicating an indication of the one or more CBGs to which the subset is assigned and whether HARQ-ACK is to be supported for the one or more CBGs to which the subset is assigned. Considering multiple subsets and multiple transmission configurations, QoS handlings as specified or otherwise indicated by the transmission configurations may involve assigning respective subsets of AI/ML parameters to one or more CBGs, and communicating the parameters may involve communicating an indication of the one or more CBGs to which the respective subsets are assigned and whether HARQ-ACK is to be supported for the one or more CBGs to which the respective subsets are assigned.

For different transmissions, such as transmissions for different iterations in different time slots, priority or importance of parameters or parameter-related data may change, and be indicated by a network device or a UE. With reference again to FIG. 7, at a time slot n the subset 710 for first layers of the model 500 may be of higher priority or importance than the subset 720 for subsequent layers, and at slot n+k, the subset 710 of parameters for the first layers are changed from higher priority or importance to lower or normal priority or importance and the subset 720 changes from lower to higher priority or importance. With such changes in priority or importance, QoS handling of each subset also changes over time. This example illustrates that communicating parameters may involve multiple iterations in which QoS handling for one or more of subsets of parameters is changed between the iterations.

One aspect of QoS handling as described herein is quantization. Low or low-precision quantization refers to using a smaller number of bits to express the value of a parameter, and high or high-precision quantization refers to using more bits to express the value and thereby provide a more exact value of the parameter. For example, for expression of the weight of a connection, low-precision quantization may use 1 bit, and high-precision quantization may use 2 bits, and an example of bit meanings under such quantizations is shown below:

| Quantization level | Value of Weight |
|---|---|
| Low-precision | 0: X1, if actual weight value < (X1 + X4)/2 |
| quantization (1 bit) | 1: X4, if actual weight value >= (X1 + X4)/2 |
| High-precision | 00: X1, if actual weight value < (X1 + X2)/2 |
| quantization (2 bits) | 01: X2, if (X1 + X2)/2 =< |
| | (actual value) <= (X2 + X3)/2 |
| | 10: X3, if (X2 + X3)/2 =< |
| | (actual value) <= (X3 + X4)/2 |
| | 11: X4, if the actual weight value >= (X3 + X4)/2 |
| | for X1 < X2 < X3 < X4 |

This is an example only, and other quantizations may be used.

Communicating parameters in adaptive QoS handling embodiments may involve communicating any one or more of the following for a higher priority or importance subset of parameters:
an indicator of higher priority or importance of the subset;
index list or other indication of parameters being communicated, such as an index list of connections between layers for which the AI/ML parameters include weights;
quantization level, for weights in indicated connections for example;
parameter values, such as weights of indicated connections for example;
gradients, of weights of indicated connections for example;
bias, of neuron nodes in indicated connections for example;
learning rate, of indicated connections for example;
convergence, of indicated connections for example;
an indication of one or more CBGs carrying the subset of parameters, such as CBG indices, for the weights of indicated connections for example;
modulation order and/or coding rate, for indicated CBG(s) for example;
ACK/NACK support, for indicated CBG(s) for example;
re-transmission support, for indicated CBG(s) for example.

Communicating parameters in adaptive QoS handling embodiments may involve communicating any one or more of the following for a lower priority or importance subset of parameters:
an indicator of lower or normal priority or importance;
an index list or other indication of parameters being communicated, such as an index list of connections between layers for which the AI/ML parameters include weights (in some embodiments, if parameters are not indicated, parameters other than those specified as higher priority or importance are lower priority or importance);
quantization level, for weights in lower priority or importance connections for example;
parameter values, such as weights in lower priority or importance connections for example;
gradients, of weights in lower priority or importance connections for example;
bias, of neuron nodes in lower priority or importance connections for example;
learning rate, of for weights in lower priority or importance connections for example;
convergence, of for weights in lower priority or importance connections for example;
an indication of one or more CBGs carrying the subset of parameters (in some embodiments, if CBGs are not indicated, CBGs other than those specified as carrying a higher priority or importance subset are presumed to carry a lower priority or importance parameter subset);
modulation order and/or coding rate;
ACK/NACK support, or presumed no support for lower priority or importance parameter subsets;
re-transmission support, lower priority or importance parameter subset.

These examples illustrate that communicating AI/ML parameters may involve communicating different information for subsets of parameters that are communicated with higher QoS handling (higher priority or importance) relative to subsets of the AI/ML parameters that are communicated with lower QoS handling (lower priority or importance).

In some adaptive QoS handling embodiments, multiple subsets of model parameters, such as all connection weights, are communicated between a UE and a network device in each iteration. A receiver (UE or network device) thereby obtains updated parameter values for an iteration, and uses the updated parameter values for its local model update.

As described elsewhere herein, transmission configurations for parameter subsets may be determined by either a network device or a UE, but may or may not necessarily be communicated between a network device and a UE. For UL learning, if a network device determines the transmission configurations, and configures which parameters are higher and lower priority or importance, the transmission configurations are communicated to the UE so that the UE can apply the configurations in communicating parameters to the network device. The transmission configurations may be communicated to a UE in RRC signaling, MAC-CE signaling, or DCI signaling, for example. Transmission configurations for UL learning may include, for example, one or more of the following: an index list or other identifiers of connection between layers for higher priority or importance parameters, an index list or other identifiers of connections between layers for lower or normal priority or importance parameters, quantization levels for higher priority or importance parameters, quantization levels for lower priority or importance parameters, CBG indices or other CBG identifiers for higher priority or importance parameters, CBG indices or other CBG identifiers for lower priority or importance parameters, and an indication as to whether HARQ-ACK is to be supported for the indicated CBGs. Transmission configurations also indicate whether a parameter type, examples of which are provided elsewhere herein, is reported. According to the transmission configurations for parameter subsets, the UE sends a UL report to inform the network device of parameter values, for a current iteration for example.

Another option for UL learning involves a UE informing a network device of the transmission configurations in UL reports for local model updates, when UL report contents are determined by the UE. For example, a UL report may include, in the first bits of the report or elsewhere, an indication of transmission configuration or format of the report, including one or more of the following: an index list or other identifiers of connection between layers for higher priority or importance parameters, an index list or other identifiers of connections between layers for lower or normal priority or importance parameters, quantization levels for higher priority or importance parameters, quantization levels for lower priority or importance parameters, CBG indices or other CBG identifiers for higher priority or importance parameters, CBG indices or other CBG identifiers for lower priority or importance parameters, and an indication as to whether HARQ-ACK is to be supported for the indicated CBGs. Transmission configurations determined by a UE and communicated to a network device also indicate whether a parameter type, examples of which are provided elsewhere herein, is reported. Remaining bits of a UL report include parameter values according to the configurations for the subsets of parameters being communicated.

Relative to using the same priority handling for all parameters of an AI/ML model, lower priority or importance transmission according to adaptive QoS handling as disclosed herein may help reduce communication overhead significantly, while maintaining training performance.

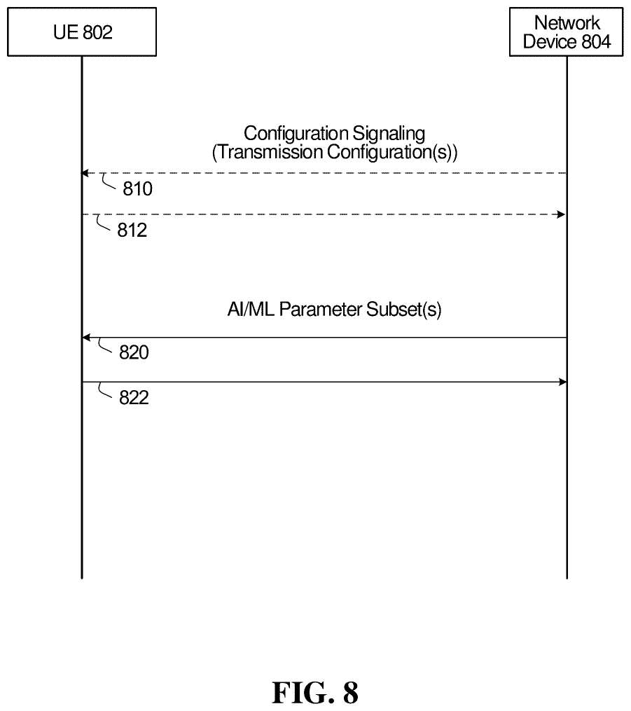

FIG. 8 is a signal flow diagram illustrating interactions between a UE 802 and a network device 804 in some embodiments. Various features related to exchanging AI/ML parameters are disclosed herein, and FIG. 8 is intended to provide a visual representation as to how features that are provided by or performed by one communication device (the UE 802 or the network device 804) may have counterpart features at another communication device (the network device 804 or the UE 802). FIG. 8 also illustrates how a transmission configuration and/or AI/ML parameter may be communicated in either direction between a UE and a network device.

For example, as disclosed elsewhere herein, one or more subsets of AI/ML parameters may be communicated, within a RAN, between a UE and a network device. Downlink communication of one or more subsets of AI/ML parameters is illustrated at 820, and involves the network device 804 transmitting the subset(s) of AI/ML parameters to the UE 802, and the UE receiving the subset(s) of AI/ML parameters from the network device. AI/ML parameters may also or instead be transmitted in an uplink direction. Uplink communication of one or more subsets of AI/ML parameters is illustrated at 822, and involves the UE 802 transmitting the subset(s) of AI/ML parameters to the network device 804, and the network device receiving the subset(s) of AI/ML parameters from the UE.

In some embodiments, one or more transmission configurations are communicated, from the network device 804 to the UE 802 as illustrated at 810. Communicating a transmission configuration at 810 may involve the network device 804 transmitting one or more transmission configurations that are determined by the network device, for example, to the UE 802, and the UE 802 receiving the transmission configuration(s) from the network device. Configuration signaling at 810 may be or include RRC signaling, MAC-CE signaling, or DCI signaling, for example. In other embodiments, a method may involve the UE 802 transmitting one or more transmission configurations to the network device 804, and the network device 804 receiving the transmission configuration(s) from the UE. This is illustrated at 812.

In general, features related to communicating between a UE and a network device may involve transmitting by the UE to the network device and receiving by the network device from the UE, and/or transmitting by the network device to the UE and receiving by the UE from the network device.

Other features disclosed herein may be provided, but are not shown in FIG. 8 in order to avoid congestion in the drawing.

For example, a transmission configuration may indicate transmission, by the UE 802 or the network device 804, and/or reception by the network device or the UE, of only one of the subsets of the AI/ML parameters, consistent with selective transmission embodiments disclosed elsewhere herein.

Communicating the parameter subset(s) at 820 and/or 822 may involve communicating (i.e., transmitting by the UE 802 or the network device 804, and/or reception by the network device or the UE) an indication of the AI/ML parameters and values of the AI/ML parameters in the one of the subsets.

Similarly, communicating other parameters or information such as a learning rate may involve transmitting by the UE 802 or the network device 804 and/or receiving by the network device or the UE.

QoS handling embodiments described at least above may involve assigning a subset or respective subsets of the AI/ML parameters to one or more CBGs, in which case a method may involve communicating (again, transmitting by the UE 802 or the network device 804, and/or reception by the network device or the UE) an indication of the one or more CBGs to which the (or each) subset is assigned and whether HARQ-ACK is to be supported for the one or more CBGs to which the (or each) subset is assigned.

Multiple iterations may involve transmitting by the UE 802 or the network device 804, and/or reception by the network device or the UE, in multiple iterations, between which QoS handling may be changed for example.

FIG. 11 is intended as an illustrative and non-limiting example of how UE features may have counterpart features at a network device, and how a UE and a network device may interact. Other features disclosed herein, even if not explicitly described with reference to FIG. 11, may be provided for a UE, for a network device, or both.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to, or to cause a processor to, communicate, within a RAN of a wireless communication network and between a UE and a network device, one or more of a plurality of subsets of AI/ML parameters. A subset of the plurality of subsets of the AI/ML parameters is communicated according to a transmission configuration, by the network device, for the subset.

Embodiments related to apparatus or non-transitory computer readable storage media for UE or network device operations may include any one or more of the following features, for example, which are also discussed elsewhere herein:
the programming includes instructions to, or to cause a processor to, communicate the transmission configuration from the network device to the UE via RRC signaling, MAC-CE signaling, or DCI signaling;
the transmission configuration indicates transmission of only one of the subsets of the AI/ML parameters;
the plurality of subsets includes multiple subsets that include common AI/ML parameters;
the programming includes instructions to, or to cause a processor to, communicate an indication of the AI/ML parameters and values of the AI/ML parameters in the one of the subsets;
the indication of the AI/ML parameters is or includes an indication of one or more AI/ML model layers for which associated parameters are communicated;
the indication of the AI/ML parameters is or includes a connection bitmap that indicates whether the AI/ML parameters in the one of the subsets include weights for connections between respective pairs of AI/ML model layers;
the indication of the AI/ML parameters is or includes a connection group bitmap that indicates whether the AI/ML parameters in the one of the subsets include weights for consecutive connections between respective series of AI/ML model layers;
the indication of the AI/ML parameters is or includes a connection start location and connection length of connections in an AI/ML model for which the AI/ML parameters in the one of the subsets include connection weights;
the programming includes instructions to, or to cause a processor to, communicate a learning rate for one or more connections in an AI/ML model for which the AI/ML parameters in the one of the subsets include connection weights;
the transmission configuration indicates QoS handing;
the QoS handling indicated by the transmission configuration is or includes any one or more of: quantization, acknowledgement/negative acknowledgement support, and re-transmission support;
the QoS handling is or includes assigning the subset of the AI/ML parameters to one or more CBGs;
the programming includes instructions to, or to cause a processor to, communicate an indication of the one or more CBGs to which the subset is assigned and whether HARQ-ACK is to be supported for the one or more CBGs to which the subset is assigned;
the programming includes instructions to, or to cause a processor to, communicate in multiple iterations in which the QoS handling is changed between the iterations.

Other features, including those disclosed herein in the context of method embodiments, may also or instead be implemented in apparatus or computer program product embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

In addition, although described primarily in the context of methods and apparatus, other implementations are also contemplated, as instructions stored on a non-transitory computer-readable medium, for example. Such media could store programming or instructions to perform any of various methods consistent with the present disclosure.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
communicating, within a radio access network (RAN) of a wireless communication network and between a user equipment (UE) and a network device, one or more of a plurality of subsets of artificial intelligence/machine learning (AI/ML) parameters,
the communicating comprising:
communicating a subset of the plurality of subsets of the AI/ML parameters according to a transmission configuration, by the network device, for the subset.

2. The method of claim 1, further comprising:
communicating the transmission configuration from the network device to the UE via radio resource control (RRC) signaling, medium access control (MAC) control element (MAC-CE) signaling, or downlink control information (DCI) signaling.

3. The method of claim 1, wherein the transmission configuration indicates transmission of only one of the plurality of subsets of the AI/ML parameters.

4. The method of claim 1, wherein the plurality of subsets comprises multiple subsets that include common AI/ML parameters.

5. The method of claim 1, wherein the communicating comprises:
communicating an indication of first AI/ML parameters and values of the first AI/ML parameters in a first subset of the plurality of subsets.

6. The method of claim 5, wherein the indication indicates one or more AI/ML model layers for which associated parameters are communicated.

7. The method of claim 5, wherein the indication comprises a connection bitmap that indicates whether the first AI/ML parameters in the first subset include weights for connections between respective pairs of AI/ML model layers.

8. The method of claim 5, wherein the indication comprises a connection group bitmap that indicates whether the first AI/ML parameters in the first subset include weights for consecutive connections between respective series of AI/ML model layers.

9. The method of claim 5, wherein the indication indicates a connection start location and a connection length of connections in an AI/ML model for which the first AI/ML parameters in the first subset include connection weights.

10. The method of claim 5, wherein the communicating further comprises:
communicating a learning rate for one or more connections in an AI/ML model for which the first AI/ML parameters in the first subset include connection weights.

11. An apparatus comprising:
at least one processor; and
a non-transitory computer readable storage medium, coupled to the at least one processor, storing programming for execution by the at least one processor, the programming including instructions to cause the apparatus to perform operations including:
communicating, within a radio access network (RAN) of a wireless communication network and between a user equipment (UE) and a network device, one or more of a plurality of subsets of artificial intelligence/machine learning (AI/ML) parameters,
wherein a subset of the plurality of subsets of the AI/ML parameters is communicated according to a transmission configuration, by the network device, for the subset.

12. The apparatus of claim 11, the operations further comprising:
communicating the transmission configuration from the network device to the UE via radio resource control (RRC) signaling, medium access control (MAC) control element (MAC-CE) signaling, or downlink control information (DCI) signaling.

13. The apparatus of claim 11, wherein the transmission configuration indicates transmission of only one of the plurality of subsets of the AI/ML parameters.

14. The apparatus of claim 11, wherein the plurality of subsets comprises multiple subsets that include common AI/ML parameters.

15. The apparatus of claim 11, the communicating comprises:
communicating an indication of first AI/ML parameters and values of the first AI/ML parameters in a first subset of the plurality of subsets.

16. The apparatus of claim 15, wherein the indication indicates one or more AI/ML model layers for which associated parameters are communicated.

17. The apparatus of claim 15, wherein the indication comprises a connection bitmap that indicates whether the first AI/ML parameters in the first subset include weights for connections between respective pairs of AI/ML model layers.

18. The apparatus of claim 15, wherein the indication comprises a connection group bitmap that indicates whether the first AI/ML parameters in the first subset include weights for consecutive connections between respective series of AI/ML model layers.

19. The apparatus of claim 15, wherein the indication indicates a connection start location and a connection length of connections in an AI/ML model for which the first AI/ML parameters in the first subset include connection weights.

20. A non-transitory computer readable medium having instructions stored thereon that, when executed by an apparatus, cause the apparatus to perform operations, the operations comprising:
communicate, within a radio access network (RAN) of a wireless communication network and between a user equipment (UE) and a network device, one or more of a plurality of subsets of artificial intelligence/machine learning (AI/ML) parameters,
wherein a subset of the plurality of subsets of the AI/ML parameters is communicated according to a transmission configuration, by the network device, for the subset.
